(19) United States
(12) Patent Application Publication
(10) Pub. No.: US 2007/0170899 A1
(43) Pub. Date: Jul. 26, 2007

(54) Power supply unit and method of using the same

(75) Inventors: Jin-Hyung Lee, Anyang-si (KR); Kyoung-Geun Lee, Suwon-si (KR); Joon-Hyun Yang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/654,619

(22) Filed: Jan. 18, 2007

(30) Foreign Application Priority Data
Jan. 19, 2006 (KR) 2006-06017

(51) Int. Cl. G05F 1/10

(52) U.S. Cl. 323/236

(57) ABSTRACT

A power supply unit is provided. The power supply unit comprises a capacitor, a power input unit supplying power to the capacitor, a temperature sensor which is incorporated into the capacitor and senses a temperature of the capacitor, and a power control unit controlling a power path supplying power from the power input unit to the capacitor based on the sensed result of the temperature sensor. The power supply unit can be used continuously by shutting off a supply of power to protect an internal circuit of a capacitor in case of the abrupt increase in internal temperature of the capacitor.

### CROSS-REFERENCE TO RELATED APPLICATIONS

This application claims the benefit under 35 U.S.C. §119(a) of Korean Patent Application No.2006-0006017, filed on Jan. 19, 2006, in the Korean Intellectual Property Office, the entire disclosure of which is hereby incorporated by reference.

### BACKGROUND OF THE INVENTION

1. Field of the Invention

The present invention relates to a power supply unit. More particularly, the present invention relates to a power supply unit in which a capacitor used for a charge of energy is incorporated.

2. Description of the Related Art

Most power supply units use aluminum electrolytic capacitors which have a large capacity for a charge of energy. However, these types of aluminum electrolytic capacitors used for the power supply unit are sensitive to temperature.

For example, an electrolyte of the electrolytic capacitor may be leaked when temperature rises according to an operating temperature of the capacitor, ripple current or an overuse in excess of a lifetime. Furthermore, serious matters such as explosions of the capacitors may occur.

Conventional methods incorporate a temperature-sensitive fuse into the capacitor so that the incorporated temperature-sensitive fuse senses an exothermic state and automatically shuts off a supply of power in the event that the inner temperature of the capacitor rises to more than a predetermined temperature.

However, a product incorporating a temperature-sensitive fuse cannot be reused once the incorporated temperature-sensitive fuse is broken by a temperature rise.

Accordingly, there is a need for an improved power supply unit that can be used continuously, and that protects capacitors from temperature increases without rendering them unusable.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a power supply unit that can be used continuously by shutting off a supply of power to protect an internal circuit of a capacitor in case an internal temperature of the capacitor abruptly increases.

The foregoing and/or other aspects of an exemplary embodiment of the present invention can be achieved by providing a power supply unit which comprises a capacitor, a power input unit, a temperature sensor and a power control unit. The power input unit supplies power to the capacitor. The temperature sensor is incorporated into the capacitor and senses a temperature of the capacitor. The power control unit controls a power path to supply power from the power input unit to the capacitor based on the sensed result of the temperature sensor.

According to an exemplary embodiment of the present invention, the temperature sensor comprises a positive temperature coefficient thermistor (PTC) device.

According to an exemplary embodiment of the present invention, the PTC device is incorporated into an anode foil of the capacitor.

According to an exemplary embodiment of the present invention, a negative (−) terminal of the PTC device is connected with a cathode (−) terminal of the capacitor and a positive (+) terminal of the PTC device as a separate terminal is connected with the power control unit.

According to an exemplary embodiment of the present invention, the power control unit comprises a switching unit and a switching control unit. The switching unit controls the power path to supply power from the power input unit to the capacitor. The switching control unit applies a switching control signal to the switching unit based on the sensed signal output from the PTC device.

According to an exemplary embodiment of the present invention, the switching control unit comprises a comparator that compares the sensed signal output from the PTC device with a predetermined reference level.

According to an exemplary embodiment of the present invention, the switching control unit controls the switching unit to shut off the power path between the power input unit and the capacitor. This is done in case a level of the sensed signal output from the PTC device is more than a predetermined reference level. The switching control unit also controls the switching unit to shut off the power path between the power input unit and the capacitor to connect the power path between the power input unit and the capacitor in case the level of the sensed signal output from the PTC device is less than the predetermined reference level.

According to an exemplary embodiment of the present invention, the capacitor comprises an aluminum electrolytic capacitor.

### BRIEF DESCRIPTION OF THE DRAWINGS

The above and other exemplary objects, features and advantages of certain exemplary embodiments of the present invention will be more apparent from the following description taken in conjunction with the accompany drawings, in which:

FIG. 1 is a control block diagram of a power supply unit according to an exemplary embodiment of the present invention;

FIG. 2 is a drawing illustrating a structure of a capacitor according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

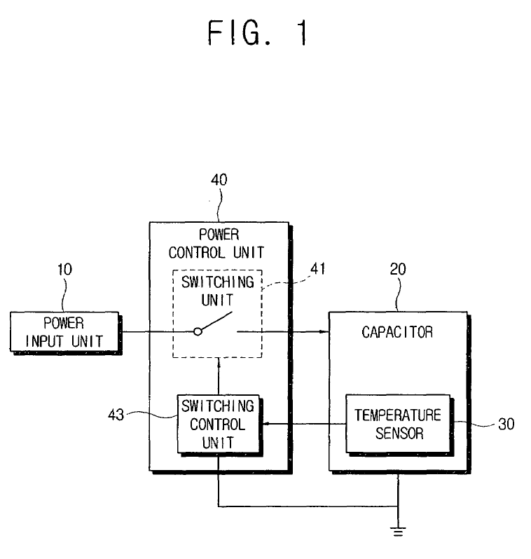

FIG. 1 is an illustration of a control block diagram of a power supply unit according to an exemplary embodiment of the present invention. As illustrated in FIG. 1, the power supply unit, according to an exemplary embodiment of the present invention, comprises a power input unit 10, a capacitor 20, a temperature sensor 30 and a power control unit 40.

The power input unit 10 supplies power to the capacitor 20 and may be an input terminal to which a power source or supplied power from the power source is input.

The capacitor 20 is charged with power supplied by the power input unit 10 and may discharge the charged power. The capacitor 20, according to an exemplary embodiment of the present invention, will be described in reference to an aluminum electrolytic capacitor.

The temperature sensor 30, according to an exemplary embodiment of the present invention, is incorporated into the capacitor 20 and senses an inner temperature of the capacitor 20. The temperature sensor 30 may be implemented by a PTC device or PTC thermistor of a positive temperature coefficient, among others.

Also, the power control unit 40 controls a power path in which power is supplied from the power input unit 10 to the capacitor 20 based on the sensed result of the temperature sensor 30. As illustrated in FIG. 1, the power control unit 40 comprises a switching unit 41 to control the power path between the power input unit 10 and the capacitor 20 and a switching control unit 43 to apply a switching-on/off control signal to the switching unit 41 based on the sensed result of the temperature sensor 30.

Here, the switching unit 41 may be implemented with a simple switching device. The switching control unit 43 may be implemented by comprising a comparator which compares a signal level output from the temperature sensor 30 with a predetermined reference level and outputs the compared result signal.

When the signal level output from the temperature sensor 30 is more than the predetermined reference level, the switching control unit 43 applies a switching-off control signal to the switching unit 41 and controls to shut off the power path between the power input unit 10 and the capacitor 20. Also, when the signal level output from the temperature sensor 30 is less than the predetermined reference level, the switching control unit 43 applies a switching-on control signal to the switching unit 41 and controls to connect the power path between the power input unit 10 and the capacitor 20.

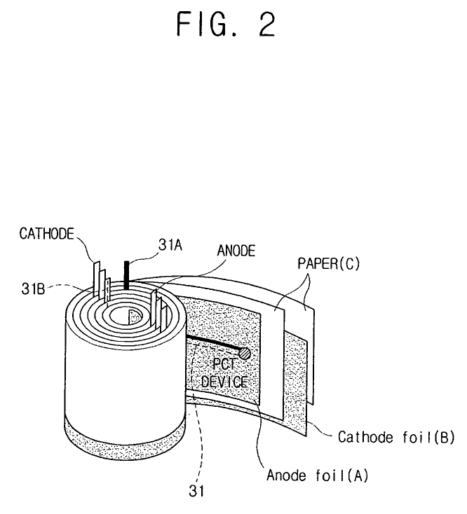

A structure of the capacitor 20, according to an exemplary embodiment of the present invention, will be described in detail with reference to FIG. 2.

As illustrated in FIG. 2, the structure of the capacitor 20 is an overlap structure of an anode foil A, a cathode foil B and a paper which encloses the anode foil A and the cathode foil B.

According to an exemplary implementation, as illustrated in FIG. 2, the PTC device 31 as a temperature sensor 30 is a temperature-sensitive device with positive thermal resistance characteristics inserted on an upper part of the anode foil A which has the highest temperature in the capacitor 20. Accordingly, the PTC device 31 can sense inner temperature of the capacitor 20.

According to an exemplary implementation, a negative (−) terminal 31B of the PTC device 31 is connected with a cathode (−) terminal of the capacitor 20. Also, a positive (+) terminal 31A of the PTC device 31 is extracted as a separate terminal to sense the inside temperature of the capacitor 20. Also, the cathode (−) terminal of the capacitor 20 and the negative (−) terminal 31B of the PTC device 31 are formed as a ground. A ground line and the positive (+) terminal 31A of the PTC device 31 are respectively connected with the power control unit 40 to implement a circuit that may output the sensed result.

Also the internal resistance of the PTC device increases when an inner temperature rises due to an inferior electrolyte, a rise of surrounding temperature, an over-voltage stress, and an excess ripple current, among others. Accordingly, the power control unit 40 compares a signal level output from the PTC device 31 with a predetermined reference level to prevent abnormal overheating of the capacitor 20 by connecting or shutting off the power path between the power input unit and the capacitor 20.

Thus, the power supply unit that uses a temperature sensing sensor without a disposable temperature fuse may be used more than once. According to an exemplary embodiment of the present invention, the disposable temperature fuse that is used does not need to be replaced once it is broken. This facilitates the continuous use of the power supply unit.

In the above exemplary embodiment of the present invention, the PTC device 31 is described as an exemplary embodiment of the present invention of the temperature sensor 30. However, another temperature-sensitive device may be used.

In the above exemplary embodiment of the present invention, the power supply unit can be used continuously by shutting off a supply of power to protect an internal circuit of a capacitor if there is an abrupt increase in internal temperature of the capacitor.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A power supply unit comprising:
a capacitor;
a power input unit for supplying power to the capacitor;
a temperature sensor for sensing a temperature of the capacitor,
wherein the temperature sensor is incorporated into the capacitor; and
a power control unit for controlling a path of power supplied from the power input unit to the capacitor based on the sensed result of the temperature sensor.

2. The power supply unit according to claim 1, wherein the temperature sensor comprises a positive temperature coefficient thermistor (PTC) device.

3. The power supply unit according to claim 2, wherein the PTC device is incorporated into an anode foil of the capacitor.

4. The power supply unit according to claim 3, wherein a negative (−) terminal of the PTC device is connected with a cathode (−) terminal of the capacitor and a positive (+) terminal of the PTC device as a separate terminal is connected with the power control unit.

5. The power supply unit according to claim 2, wherein a negative (−) terminal of the PTC device is connected with a cathode (−) terminal of the capacitor and a positive (+) terminal of the PTC device as a separate terminal is connected with the power control unit.

6. The power supply unit according to claim 2, wherein the power control unit comprises a switching unit for controlling the path of power supplied from the power input unit to the capacitor and a switching control unit for applying a switching control signal to the switching unit based on the sensed signal output from the PTC device.

7. The power supply unit according to claim 6, wherein the switching control unit comprises a comparator for comparing the sensed signal output from the PTC device with a predetermined reference level.

8. The power supply unit according to claim 7, wherein the switching control unit controls the switching unit to shut off the power path between the power input unit and the capacitor if a level of the sensed signal output from the PTC device is more than a predetermined reference level and to connect the path of power between the power input unit and the capacitor if the level of the sensed signal output from the PTC device is less than the predetermined reference level.

9. The power supply unit according to claim 8, wherein the capacitor comprises an aluminum electrolytic capacitor.

10. The power supply unit according to claim 1, wherein the capacitor comprises an aluminum electrolytic capacitor.

11. A power supply unit comprising:
a capacitor;
a power input unit for supplying power to the capacitor;
a temperature sensor for sensing a temperature of the capacitor,
wherein the temperature sensor comprises a positive temperature coefficient thermistor (PTC) device; and
a power control unit for controlling a path of power supplied from the power input unit to the capacitor based on the sensed result of the temperature sensor.

12. The power supply unit according to claim 11, wherein the PTC device is incorporated into an anode foil of the capacitor.

13. The power supply unit according to claim 12, wherein a negative (−) terminal of the PTC device is connected with a cathode (−) terminal of the capacitor and a positive (+) terminal of the PTC device as a separate terminal is connected with the power control unit.

14. The power supply unit according to claim 11, wherein a negative (−) terminal of the PTC device is connected with a cathode (−) terminal of the capacitor and a positive (+) terminal of the PTC device as a separate terminal is connected with the power control unit.

15. The power supply unit according to claim 11, wherein the power control unit comprises a switching unit for controlling the path of power supplied from the power input unit to the capacitor and a switching control unit for applying a switching control signal to the switching unit based on the sensed signal output from the PTC device.

16. The power supply unit according to claim 15, wherein the switching control unit comprises a comparator for comparing the sensed signal output from the PTC device with a predetermined reference level.

17. The power supply unit according to claim 16, wherein the switching control unit controls the switching unit to shut off the power path between the power input unit and the capacitor if a level of the sensed signal output from the PTC device is more than a predetermined reference level and to connect the path of power between the power input unit and the capacitor if the level of the sensed signal output from the PTC device is less than the predetermined reference level.

18. The power supply unit according to claim 17, wherein the capacitor comprises an aluminum electrolytic capacitor.

19. The power supply unit according to claim 11, wherein the capacitor comprises an aluminum electrolytic capacitor.

20. A method of supplying power, comprising:
supplying power to a capacitor;
sensing a temperature of the capacitor using a temperature sensor; and
controlling a path for supplying power from a power input unit to the capacitor based on the sensed result of the temperature sensor.
